(19) United States
(12) Patent Application Publication
(10) Pub. No.: US 2025/0181426 A1
(43) Pub. Date: Jun. 5, 2025

(54) TECHNIQUES FOR GENERATING DATA PROCESSING PIPELINES

(71) Applicant: VIANAI SYSTEMS, INC., Palo Alto, CA (US)

(72) Inventor: Xiwei ZHOU, Mountain View, CA (US)

(21) Appl. No.: 18/961,240

(22) Filed: Nov. 26, 2024

Related U.S. Application Data
(60) Provisional application No. 63/605,176, filed on Dec. 1, 2023.

(51) Int. Cl. G06F 9/54; G06F 9/451

(52) U.S. Cl. CPC G06F 9/543; G06F 9/451

(57) ABSTRACT

Techniques for generating data processing pipelines include receiving user input via a user interface, and generating, based on the user input, a data processing pipeline that includes a set of predefined services, wherein the set of predefined services are associated with the user input.

### CROSS-REFERENCE TO RELATED APPLICATIONS

This application claims priority benefit of the United States Provisional patent application titled, “TECHNIQUES FOR GENERATING NATURAL LANGUAGE PROCESSING PIPELINES USING LARGE LANGUAGE MODELS,” filed on Dec. 1, 2023, and having Ser. No. 63/605,176. The subject matter of this related application is hereby incorporated herein by reference.

### BACKGROUND

### Field of the Various Embodiments

Embodiments of the present invention relate generally to computer science, data processing, and machine learning, and more specifically, techniques for generating data processing pipelines.

### Description of the Related Art

A data processing pipeline is a structured sequence of actions that need to be completed in order to perform a particular task. Typically, each action in a pipeline is dependent on the completion of a previous action, and the output of each action can be input into one or more next actions, if any, in the pipeline. Pipelines have been employed in various software applications, including natural language processing (NLP) applications in which a NLP pipeline can be used to process natural language text.

One approach for designing NLP pipelines is for a developer with significant expertise to write program code for the NLP pipeline. One drawback of this approach for designing NLP pipelines is the developer needs to write or modify the program code for each task that needs to be performed. For example, the program code for an NLP pipeline needs to be modified whenever the NLP pipeline is applied to process different data. Few, if any, techniques currently exist for designing data processing pipelines, and NLP pipelines in particular, that do not require the manual writing or modification of program code.

As the foregoing indicates, what is needed in the art are more effective techniques for generating data processing pipelines.

### SUMMARY

One embodiment of the present disclosure sets forth a computer-implemented method for generating data processing pipelines. The method includes receiving user input via a user interface. The method further includes generating, based on the user input, a data processing pipeline that includes a set of predefined services, where the set of predefined services are associated with the user input.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, data processing pipelines, including pipelines for natural language processing tasks, can be generated without writing program code. Instead, the disclosed techniques provide predefined services that can be selected via a user interface to efficiently design data processing pipelines. In addition, the disclosed techniques permit data processing pipelines to be generated from textual input using a language model. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computing system configured to implement one or more aspects of various embodiments;

FIG. 2 is a more detailed illustration of the natural language processing (NLP) application of FIG. 1, according to various embodiments;

FIG. 3 is a more detailed illustration of the designer of FIG. 2, according to various embodiments;

FIG. 4 illustrates an exemplar user interface for designing an NLP pipeline, according to various embodiments;

FIG. 5 illustrates another exemplar user interface for designing an NLP pipeline, according to various embodiments;

FIG. 6 is a flow diagram of method steps for orchestrating an NLP pipeline, according to various embodiments; and

FIG. 7 is a flow diagram of method steps for generating an NLP pipeline, according to various embodiments.

### DETAILED DESCRIPTION

In the following description, various concepts and examples are disclosed that provide more effective techniques for accessing business data using executable code included in authorization identifiers. The numerous specific details set forth will provide artisans with a more thorough understanding of the various embodiments. However, it will be apparent to one skilled in the art that the inventive concepts can be practiced without one or more of these specific details.

### System Overview

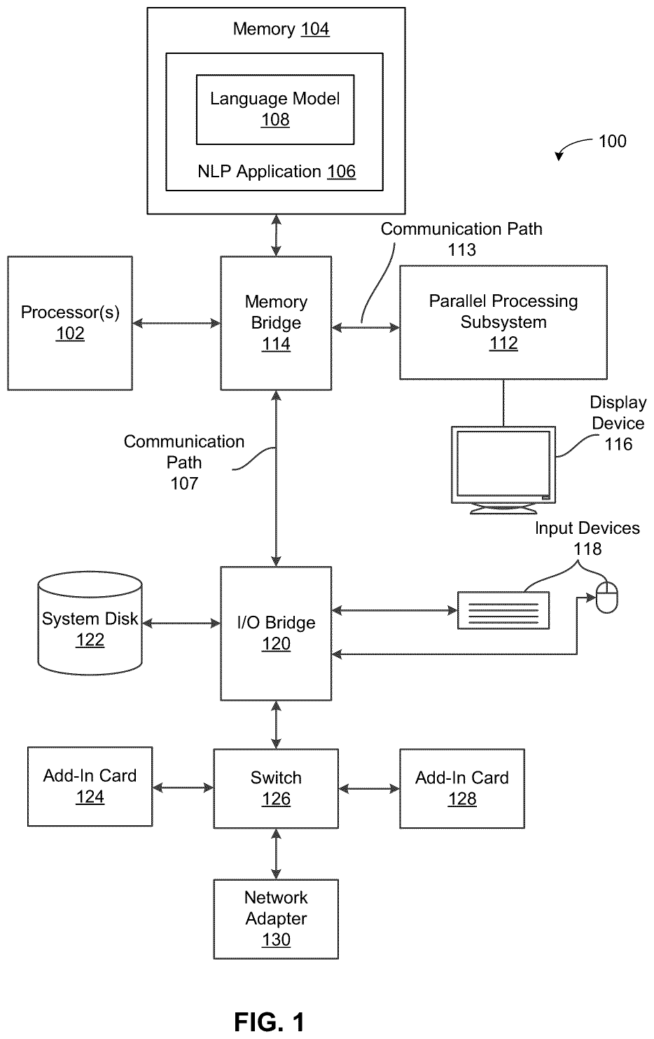

FIG. 1 is a block diagram illustrating a computing system 100 configured to implement one or more aspects of various embodiments. Computing system 100 may be any type of computing device, including, without limitation, a server machine, a server platform, a desktop machine, a laptop machine, a hand-held/mobile device, a digital kiosk, an in-vehicle infotainment system, and/or a wearable device. In some embodiments, computing system 100 is a server machine operating in a data center or a cloud computing environment that provides scalable computing resources as a service over a network.

As shown, computing system 100 includes, without limitation, processor(s) 102 and memory(ies) 104 coupled to a parallel processing subsystem 112 via a memory bridge 114 and a communication path 113. Memory bridge 114 is further coupled to an I/O (input/output) bridge 120 via a communication path 107, and I/O bridge 120 is, in turn, coupled to a switch 126.

In various embodiments, I/O bridge 120 is configured to receive user input information from optional input devices 118, such as a keyboard, mouse, touch screen, sensor data analysis (e.g., evaluating gestures, speech, or other information about one or more uses in a field of view or sensory field of one or more sensors), and/or the like, and forward the input information to the processor(s) 102 for processing. In some embodiments, computing system 100 may be a server in a cloud computing environment. In such embodiments, computing system 100 may not include input devices 118, but may receive equivalent input information by receiving commands (e.g., responsive to one or more inputs from a remote computing device) in the form of messages transmitted over a network and received via the network adapter 130. In some embodiments, switch 126 is configured to provide connections between I/O bridge 120 and other components of the computing system 100, such as a network adapter 130 and various add-in cards 124 and 128.

In some embodiments, I/O bridge 120 is coupled to a system disk 122 that may be configured to store content and applications and data for use by processor(s) 102 and parallel processing subsystem 112. In some embodiments, system disk 122 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 120 as well.

In various embodiments, memory bridge 114 may be a Northbridge chip, and I/O bridge 120 may be a Southbridge chip. In addition, communication paths 107 and 113, as well as other communication paths within computing system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to an optional display device 116 that may be any conventional cathode ray tube, liquid crystal display, light-emitting diode display, and/or the like. In such embodiments, the parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In some embodiments, the parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memory 104 includes at least one device driver configured to manage the processing operations of the one or more PPUs within parallel processing subsystem 312.

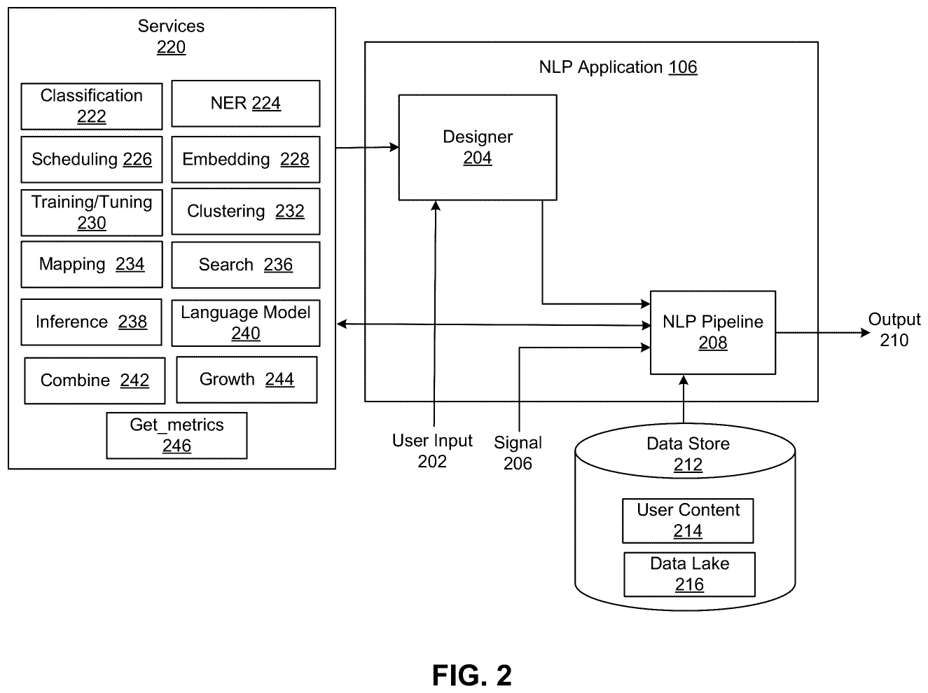

In addition, memory 104 includes NLP application 106 that responds to user input by generating an NLP pipeline with user defined parameters. Although described herein primarily with respect to NLP pipelines as a reference example, in some embodiments, any data processing pipelines, including pipelines for processing data other than natural language text, can be generated according to techniques disclosed herein. Alternatively, NLP application 106 can use a computational graph predicted by language model 108 to generate the NLP pipeline. During execution, the generated NLP pipeline uses one or more previously implemented services to process data, such as user input. In some embodiments, NLP application 106 can use language model 108 to generate an NLP pipeline from user input data, such as by using language model 108 to process a few-shot prompt that asks language model 108 to generate the NLP pipeline and includes the user input, available services that can be included in the NLP pipeline, and a few examples of user inputs and corresponding pipelines. NLP application 106 can automate execution of the NLP pipeline at scheduled times or after a signal triggers execution of the NLP pipeline. The operations performed by NLP application 106 are described in greater detail below in conjunction with FIGS. 2-6.

Language model 108 can receive input data, such as a few-shot prompt that includes a user input, available services, and a few examples of user inputs and corresponding pipelines that each include one or more of the available services. Given such data, language model 108 can generate a computational graph that defines a pipeline corresponding to the user input. Language model 108 can be trained for any purpose and using any suitable training technique, such as supervised, unsupervised, and/or reinforcement learning. Language model 108 can be implemented as any technically feasible machine learning model capable of processing natural language text, including, but not limited to, a neural network (e.g., a language model), a transformer, a generative pre-trained transformer (GPT), and/or the like. In some embodiments, language model 108 can execute on computing system 100 or elsewhere, such as in a cloud computing environment from which language model 108 is accessed via an application programming interface (API).

In various embodiments, parallel processing subsystem 112 may be integrated with one or more of the other elements of FIG. 1 to form a single system. For example, parallel processing subsystem 112 may be integrated with processor 102 and other connection circuitry on a single chip to form a system on a chip (SoC).

In some embodiments, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, memory 104 could be connected to processor(s) 102 directly rather than through memory bridge 114, and other devices may communicate with memory 104 via memory bridge 114 and processor(s) 102. In other embodiments, parallel processing subsystem 112 may be connected to I/O bridge 120 or directly to processor(s) 102, rather than to memory bridge 114. In still other embodiments, I/O bridge 120 and memory bridge 114 may be integrated into a single chip instead of existing as one or more discrete devices. In certain embodiments, one or more components shown in FIG. 1 may not be present. For example, switch 126 could be eliminated, and network adapter 130 and add-in cards 124, 128 would connect directly to I/O bridge 120. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2 is a more detailed illustration of NLP application 106 of FIG. 1, according to various embodiments. As shown, NLP application 106 includes, without limitation, a designer 204 and an NLP pipeline 208. In operation, NLP application 106 receives user input 202 and generates output 210. NLP application 106 has access to services 220 that include, without limitation, a classification service 222, a name entity recognition (NER) service 224, a scheduling service 226, an embedding service 228, a training/tuning service 230, a clustering service 232, a mapping service 234, a search service 236, an inference service 238, a language model service 240, a combine service 242, a growth service 244, and a get_metrics service 246. Any other suitable services can be used in some other embodiments. For example, in some embodiments, the services can also include one or more agents, such as a large language model (LLM) agent. NLP application 106 further has access to user content 214 and a data lake 216 stored in a data store 212. Although shown as distinct from NLP application 106, in some embodiments, one or more of services 220 can be included in NLP application 106.

In operation, NLP application 106 receives user input 202 and generates an output 210 using one or more services 220, user content 214, and/or data lake 216. In some embodiments, NLP application 106 generates and executes NLP pipeline 208 with parameters from user input 202 for corresponding services 220.

In some embodiments, user input 202 can be text, such as a query, that is included in a textual prompt for input into a trained language model (e.g., language model 108) that outputs a computational graph corresponding to the NLP pipeline 208. In some other embodiments, user input 202 can include a series of user instructions when interacting with a user interface (UI) (not shown) to configure NLP pipeline 208.

Designer 204 can receive user input 202, such as a user query or user instructions via the UI, and generate NLP pipeline 208 that is a computational graph based on user input 202. In some embodiments, designer 204 includes the trained language model (e.g., language model 108) that breaks down a user query into one or more steps, such as data acquisition, data processing, and/or data presentation. In each step, the language model can configure corresponding parameters of one or more services 220 that are interpreted from user input 202. The language model can then orchestrate the one or more steps into NLP pipeline 208, and NLP application 106 can execute NLP pipeline 208 to respond to the user query. Alternatively, the user can input instructions into the UI, described above, that permits the user to select and configure one or more services 220, as well as orchestrate those services 220 together into NPL pipeline 208, which can then be executed by NLP application 106.

NLP pipeline 208 is a computational graph that includes a series of operations, also referred to herein as “nodes,” that can be executed sequentially to generate a result. The nodes are the computation units that process incoming data and produce outputs. Each node can utilize one or more services 220 to process data. Some nodes can further transform data from a node input format to a node output format. For example, a search node could find relevant documents in user content 214, a mapping node could map input data into a different schema, and a classification node could take input data and make a classification (e.g., a sentiment classification). In some embodiments, one or nodes of NPL pipeline 208 can be agents (e.g., language model agents), or NLP pipeline 208 can be an agent. NLP pipeline 208 can be manually configured by a user interacting with the UI or automatically generated using a language model, described above. NLP pipeline 208 can use one or more services 220 to execute the computational graph and generate output 210.

As described, during execution, the nodes of NLP pipeline 208 can use one or more previously implemented services 220 to respond to user input 202. For example, in response to the user input “Revenue growth rate of Spirit airline compare to CPI growth rate”, NLP application 106 could use the get_metrics service 246 to pull, from data lake 216, data for both “Spirit airline” and “CPI”, use growth service 244 to calculate the growth rate for each, use combine service 242 to align the revenue growth rate over time for both, and output a text file or draw a line chart comparing the revenue growth rate of Spirit airline and the CPI growth rate.

In some embodiments, NLP application 106 can automate execution of NLP pipeline 208 at scheduled times using scheduling service 226. In some embodiments, NLP application 146 can execute NLP pipeline 208 upon receiving a triggering signal 206.

Signal 206 can automatically invoke NLP pipeline 208 by triggering an event, or signal 206 can be a notification to start invoking a specific operation in NLP pipeline 208. When automating NLP pipeline 208 with signal 206, NLP pipeline 208 can use event listeners, interrupts, polling mechanisms, and/or the like to obtain signal 206. Examples of signal 206 include pre-save and post-save signals that are triggered to invoke NLP pipeline 208 before and after storing a machine learning model or other data in data store 212. Below is an example of a code snippet to automatically trigger NLP pipeline 208 invocation using a post-save signal.

@receiver(post_save, sender=DataCandidate)
def datasource_periodic_task_update(sender, instance, **kwargs):

Services 220 are processes or algorithms that perform specific functions. Services 220 can be registered to NLP application 106 and used/re-used thereafter in NLP pipelines. Illustratively, services 220 include a classification service 222 that classifies data, an NER service 224 that identifies and classifies categories of objects in text, a scheduling service 226 that schedules tasks for execution, an embedding service 228 that generates embeddings from input, a training/tuning service 230 that trains or fine tunes machine learning models to perform specific tasks, a clustering service 232 that clusters input data, a mapping service 234 that maps data to one or more most similar fields, a search service 236 that performs a searching technique to retrieve data (e.g., documents that are relevant to a user query), an inference service 238 that applies trained and/or fine-tuned machine learning models and/or other techniques (e.g., rule-based techniques) to generate results, a language model service 240 that provides a language model (e.g., a large language model that executes locally or in a cloud computing system), a combine service 242 that compares variations of different variables, a growth service 244 that computes a variable's change over time, and a get_metrics service 246 that computes and/or retrieves metrics associated with data. More generally, services 220 can include any technically feasible services that can be used in any suitable NLP pipelines by NLP application 106. Another example of a service is an NER enrichment service. Yet another example of a service is an agent, such as an LLM agent. Services 220 can execute on computing system 100 and/or any other computing system, such as a cloud computing system.

Data store 212 stores user content 214 and data lake 216. Data store 212 provides non-volatile storage for NLP application 106 and data in computing system 100. For example, and without limitation, training data, trained (or deployed) machine learning models, data that is input into and/or output by trained machine learning models, and/or application data, may be stored in data store 212. In some embodiments, data store 212 may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, data store 212 can be a network attached storage (NAS) and/or a storage area-network (SAN).

User content 214 is data provided by a user that NLP pipeline 208 can process when generating output 210. User content 214 can include messages, documents, questions, reviews, and/or the like. User content 214 can offer context, intent, and specific information that guides how NLP pipeline 208 interprets and responds to user content 214, such as a question.

Data lake 216 is a repository of NLP application 106 content types, such as social media text, transcripts, documents, and/or the like. Data lake 216 stores raw, structured, semi-structured, and/or unstructured data, which can include text, audio, images, logs, etc. The data stored in data lake 216 can be used for various NLP tasks, such as training language model 118, extracting valuable insights from the data when generating output 210, and/or the like.

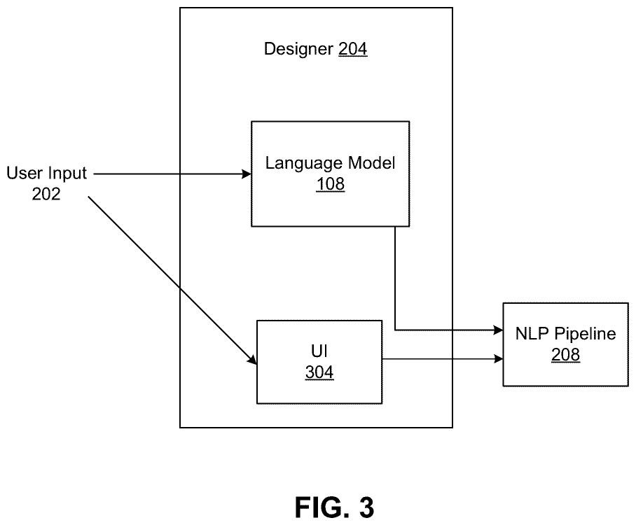

FIG. 3 is a more detailed illustration of designer 204 of FIG. 2, according to various embodiments. As shown, designer 204 includes, without limitation, language model 108 and a UI 304. In operation, designer 204 receives user input 202 and generates NLP pipeline 208.

UI 304 can be a component of designer 204 that allows users to manually design NLP pipeline 208, including modifying internal parameters of NLP pipeline 208. UI 304 can display pipelines, nodes thereof, and panels, among other things.

As described, each pipeline created using UI 304 orchestrates multiple nodes to achieve a certain data processing goal. In some embodiments, pipelines can be configured as services with flexible input parameters to improve the reusability of the pipelines. For example, a pipeline that is configured as a service could be invoked with an API end point. Below is an example of an API end point.

pipeline: data ingest
payload: ″{′web reader′: {′urls′: [′https://abc.com/category/news_002.html′]}}″

The “data ingest” is the pipeline name, while the “web reader” is the name of one of the operators in the pipeline. The pipeline takes “urls” as a parameter. The payload allows the pipeline to use the payload for operator name “web reader” in the pipeline, which pulls data from “https://abc.com/category/news_002.html”, then continues downstream activities of the pipeline with default configured parameters.

In some embodiments, UI 304 includes panels (not shown) that allow users of UI 304 to interact with specific UI 304 elements. For example, a pipeline visualization panel could display the overall pipeline logic and visualize the whole flow of NLP pipeline 208. As another example, a transformation specification panel could show the parameters of each node of a pipeline, dependencies, and services 220 involved in the node. In yet another example, a result preview panel could show an output of a selected node or an entire NLP pipeline. In such cases, the result preview panel allows a user to modify an NLP pipeline over multiple iterations to get a desired response from an individual node and/or achieve certain expected outputs.

Language model 108 can receive user input 202 and dynamically generate a computational graph based on user input 202. For example, when the user enters a query, such as “Show the revenue of South West last 10 years”, designer 204 could generate a prompt that asks language model 108 to generate an NLP pipeline and includes the query, available services, and examples of similar user queries and corresponding pipelines, and input the prompt into language model 108 to generate the following computational graph:

{ ″method″: ″growth″, ″args″: { ″series″: { ″method″:″get_metrics″,
″args″:{″query″:″South West′s revenue last 10 years″} } } }

Language model 108 can also receive user input 202, definitions of available services, and one or more examples similar to the user query in user input 202, referred to herein as few shot examples. The few shot examples can be predefined samples or samples provided by the user to augment the performance of language model 108 when generating NLP pipeline 208. For example, the few shot examples could include user queries and associated NLP pipelines that were manually designed, assigned an identifier (ID), and stored. In such cases, the few shot examples can be selected in any technically feasible manner. For example, in some embodiments, the few shot examples can include NLP pipelines with different combinations of services that are representative of most or all of the ways that the services can be used together. As another example, in some embodiments, the few shot examples can include NLP pipelines that are selected using a similarity search in which a number of stored examples of NLP pipelines associated with user queries that are most similar to the user query in user input 202 are selected. In some embodiments, the few shot examples can include pairs of the user queries and corresponding computational graphs for NLP pipelines, including the services and arguments in those NLP pipelines. For example, for a new NLP pipeline 208 that computes business metrics, the following description of available services (referred to as methods) can be included in the prompt to generate NLP pipeline 208:

There are multiple company's business metrics in JSONL format as [{id, date, value}] BUSINESS_METRICS of COMPANY_NAME, the business_metrics could be: operation cost, revenue, This system has following methods:

metrics: [{id, date, value}]
get_metrics(query: String) -> metrics
growth(series: List({})) -> new_metrics
combine(series_1:[{id, date, value1}], series_2:[{id, date, value2}]) -> metrics_3[{

In addition, the following few shot examples can be included in the prompt to language model 108 to generate NLP pipeline 208:

### Example 1

input: GM′s revenue last 10 years output: { ″method″: ″get_metrics″, ″args″:
{″query″:″GM′s revenue last 10 years″} }

### Example 2

input: Ford′s margine growth last 5 years output: { ″method″: ″growth″, ″args″: { ″series″:
{ ″method″:″get_metrics″, ″args″:{″query″:″GM′s revenue last 10 years″} } } }

### Example 3

input: GM′s revenue growth last 10 years compare to Ford output: { ″method″:
″combine″, ″args″: { ″series_1″: { ″method″: ″growth″, ″args″: { ″series″: {
″method″:″get_metrics″, ″args″:{″query″:″GM′s revenue last 10 years″} } } }, ″series_2″: {
″method″: ″growth″, ″args″: { ″series″: { ″method″:″get_metrics″, ″args″:{″query″:″Ford′s
revenue last 10 years″} } } } }

When executing a new user input 202, adding the few shot examples to the language model 108 prompt allows language model 108 to automatically generate the computational graph of the new NLP pipeline 208 for the new user query. For example, after adding examples 1-3 above to the input prompt of language model 108 as few shot examples, language model 108 can generate the following computational graph for NLP pipeline 208.

{ ″method″: ″growth″, ″args″: { ″series″: { ″method″:″get_metrics″,
″args″:{″query″:″South West′s revenue last 10 years″} } } }

Language model 108 can be trained for any purpose and using any suitable training technique, such as supervised, unsupervised, and/or reinforcement learning. In various embodiments, language model 108 can be implemented as any technically feasible language model, including, but not limited to, a neural network (e.g., a language model), a transformer, a generative pre-trained transformer (GPT), and/or the like. In some embodiments, instead of few-shot examples, language model 108 can be re-trained (i.e., fine tuned) for generating NLP pipelines using training data that includes, for example, example user inputs and corresponding pipelines.

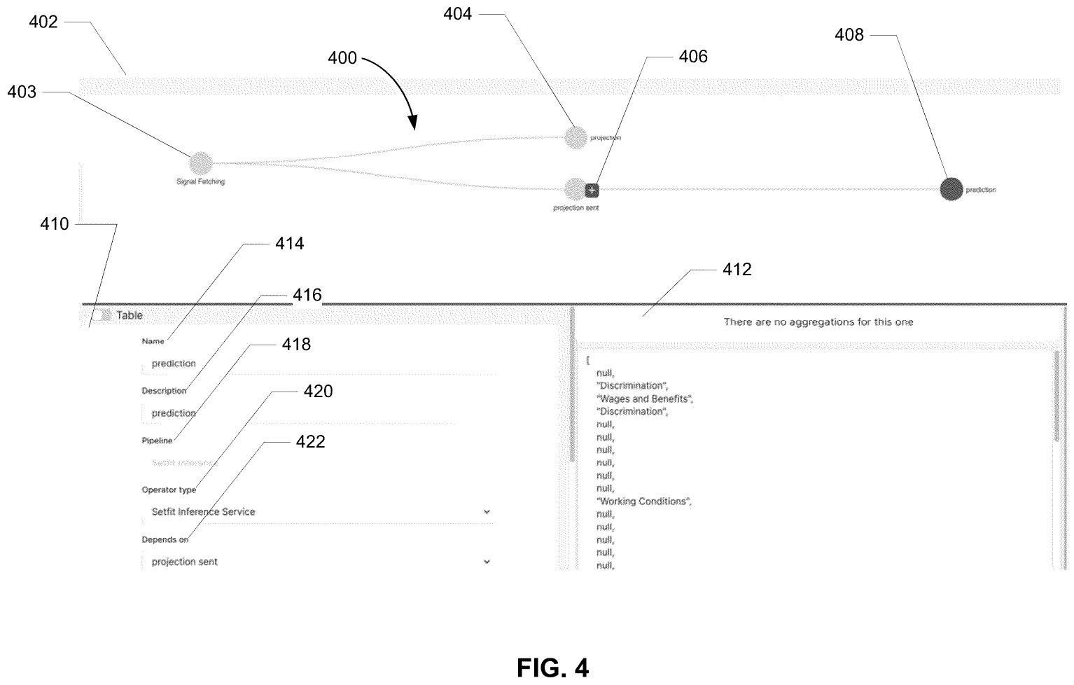

FIG. 4 illustrates an exemplar user interface for designing an NLP pipeline 400, according to various embodiments. As shown, a pipeline visualization user interface (UI) 402 displays a visualization of the whole flow of NLP pipeline 400, which is a manually designed NLP pipeline for a topic classification task. NLP pipeline 400 includes four nodes 403, 404, 406, and 408, as well as interconnections between the nodes and dependencies of each node on one or more previous nodes. For example, node 408 is dependent on node 406, which is dependent on node 403. Illustratively, node 403 is a signal fetching node that retrieves data signals for processing. Node 404 is a projection node that computes a projection of signals fetched by the node 403 to extract certain fields therein. Node 406 is a projection sent node that computes a projection of signals fetched by the node 403 and sends fields that are extracted by the projection to node 408, which is a prediction node that makes predictions given the fields extracted by the node 406.

As shown, pipeline visualization UI 402 can display UI elements for adding nodes, removing nodes, modifying the parameters and configurations of nodes, specifying the inputs and outputs of nodes, and/or connecting nodes to other nodes. For example, an add new node button 407 allows a user to add a new node between node 406 and node 408. Node 408 is a currently active node and is shown with a darker color indicating that node 408 is selected. The corresponding input parameters and outputs of the selected node 408 are shown with respect to a transformation specification panel 410 and a result preview panel 412, respectively.

Transformation specification panel 410 is located on the left side of pipeline visualization UI 402 and shows the parameters of the selected node 408, such as a name 414, a description 416, a pipeline name 418, an operator type 420, and dependencies 422. As described above in conjunction with FIG. 3, operator type 420 defines which service(s) among services 220 are used and being computed by node 408. Illustratively, the operator type 420 for node 408 is a setfit inference service, which is an efficient framework for few shot fine-tuning of Sentence Transformers. Dependencies 422 show that node 408 is dependent on node 406 and receives the output of node 406 as input.

Result preview panel 412 is located on the right side of pipeline visualization UI 402 and displays a prediction output of node 408. The classification results in result preview panel 412 show the classes of topics for input sentences. For example, “null” shows that no class has been determined, while other classes that have been determined include “discrimination”, “wages and benefits”, and “working conditions”.

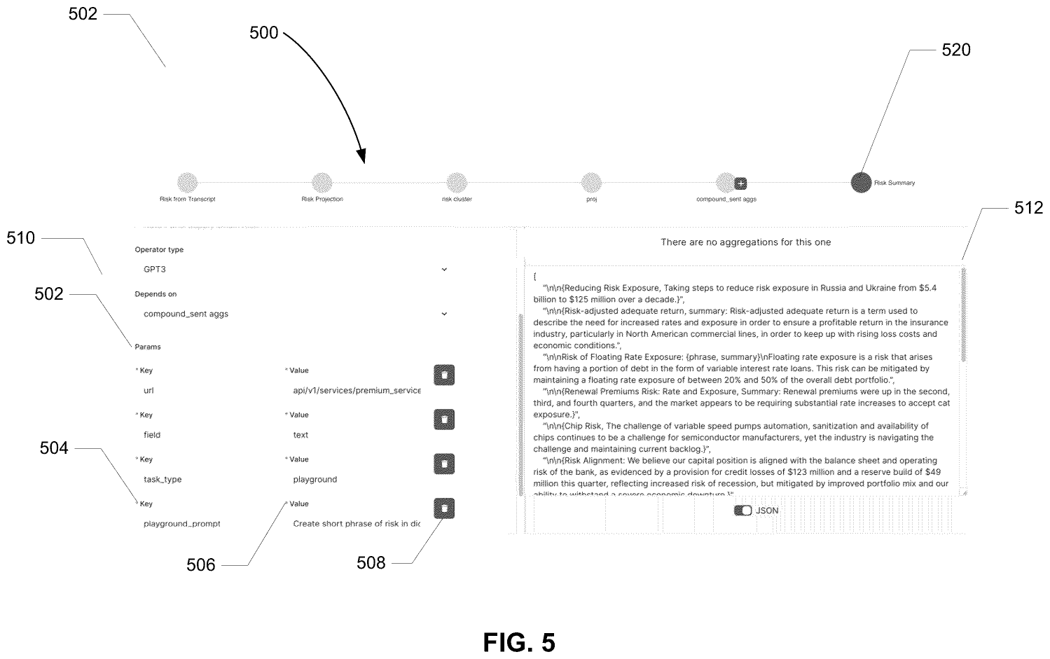

FIG. 5 illustrates another exemplar user interface for designing an NLP pipeline 500, according to various embodiments. As shown, pipeline 500 includes nodes to collect data through best match 25 (BM25), and then analyze and cluster the collected data in different risk buckets. NLP pipeline 500 is a manually designed NLP pipeline for a risk summarization task. Illustratively, NLP pipeline 208 includes six nodes, and a risk summary node is selected.

Similar to FIG. 4, a left panel 510 of a pipeline visualization UI 502 is a transformation specification panel, and a right panel 512 of pipeline visualization UI 500 is a result preview panel. In left panel 510, params 502 shows input parameters of a selected node 520, and each parameter can have a key 504 and a corresponding value 506. For example, key 504 could be a uniform resource locator (URL) and the corresponding value 506 could be the URL endpoint. As another example, a key could be a task type and a corresponding value could be playground. A delete button 508 allows a user to delete a key, value pair for any of the parameters of the selected node.

Although exemplar user interfaces for manually designing NLP pipelines are shown in FIGS. 4-5 for illustrative purposes, in some embodiments, user interfaces can permit NLP pipelines to be automatically generated using language models, as described above in conjunction with FIG. 3. For example, in such cases, NLP pipelines that were manually designed can be stored and used as examples in few-shot prompts that ask the language models to generate the NLP pipelines.

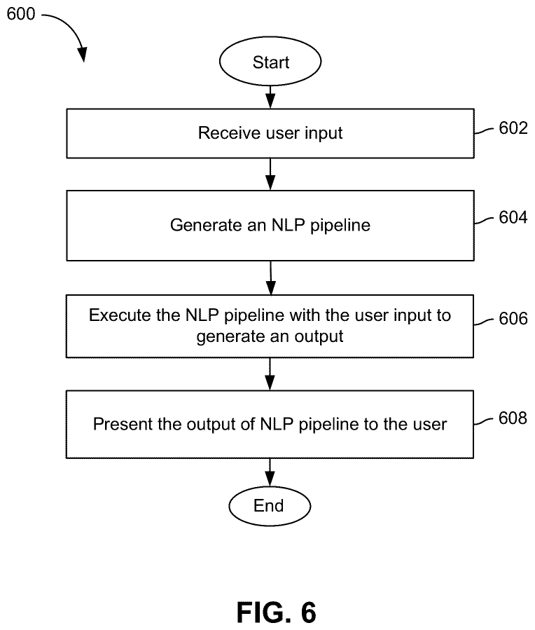

FIG. 6 is a flow diagram of method steps for orchestrating a new NLP pipeline, according to various embodiments. Although the method steps are described in conjunction with FIGS. 1-3, persons skilled in the art will understand that any system configured to perform the method steps, in any order, falls within the scope of the present invention.

As shown, a method 600 begins at step 602, where NLP application 106 receives user input 202. In some embodiments, user input 202 can be text, such as a query, that is included in a textual prompt for input into a trained language model (e.g., language model 108). In some other embodiments, user input 202 can include a series of user instructions when interacting with a UI to configure NLP pipeline 208.

At step 604, designer 204 of NLP application 106 generates an NLP pipeline 208. After receiving user input 202, such as a user query or user instructions via the UI, designer 204 generates NLP pipeline 208 that is a computational graph based on user input 202. In some embodiments, designer 204 includes a trained language model (e.g., language model 108) that breaks down a user query into one or more steps, such as data acquisition, data processing, and/or data presentation. In each step, the language model can configure corresponding parameters of one or more services 220 that are interpreted from user input 202. The language model can then orchestrate the one or more steps into NLP pipeline 208. Alternatively, the user can input instructions into the UI, described above, that permits the user to select and configure one or more services 220, as well as orchestrate those services 220 together into NPL pipeline 208.

At step 606, NLP application 106 executes NLP pipeline 208 with user input 202 to generate output 210. During execution, the generated NLP pipeline 208 can use one or more previously implemented services 220 to respond to user input 202. In some embodiments, NLP application 106 can automate execution of NLP pipeline 208 at scheduled times using scheduling service 226. In some embodiments, NLP application 146 can execute NLP pipeline 208 upon receiving a triggering signal 206, as described above in conjunction with FIG. 3.

At step 608, NLP application 106 presents an output of NLP pipeline 208 to the user. NLP application 106 can present output 210 as a text file, draw a graph (e.g., a line or bar chart), generate a spreadsheet, and/or using any suitable presentation technique. In some embodiments, NLP pipelines can be configured as services with flexible input parameters to improve the reusability of the pipelines. For example, an NLP pipeline that is configured as a service could be invoked with an API end point. In some embodiments, a result preview panel could show an output of a selected node or an entire pipeline. In such cases, the result preview panel allows the user to iteratively modify nodes and/or the entire pipeline, view results output by the nodes and/or entire pipeline, until expected results are achieved.

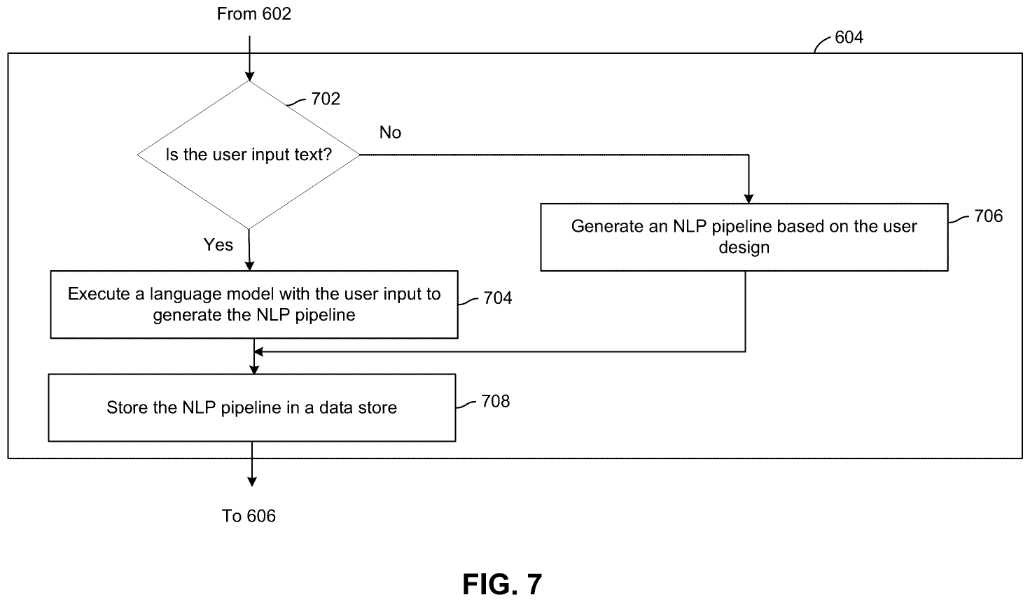

FIG. 7 is a flow diagram of method steps for generating a new NLP pipeline at step 604 of method 600, according to various embodiments. Although the method steps are described in conjunction with FIGS. 1-3, persons skilled in the art will understand that any system configured to perform the method steps, in any order, falls within the scope of the present invention.

As shown, at step 702, which continues from step 602, when the user input 202 is a text, such as a query, then method 600 continues to step 704, where designer 204 executes a language model (e.g., language model 108) to generate NLP pipeline 208. The language model receives a prompt that asks the language model to generate an NLP pipeline and includes the textual user input 202, and the language model dynamically generates a computational graph defining the NLP pipeline. The language model can also receive user input 202 and few shot examples similar to the user query. The few shot examples can be predefined samples or samples provided by the user to augment the performance of the language model when generating NLP pipeline 208. The few shot examples can include pairs of example user queries and corresponding computational graphs for NLP pipelines, including the services and arguments in those NLP pipelines, as described above in conjunction with FIG. 3. Designer 204 can generate a prompt that includes the query, available services, and examples of similar user queries and corresponding pipelines, and input the prompt into the language model to generate NLP pipeline 208.

On the other hand, if at step 702, the user input is not text but is instead a series of user instructions when interacting with a UI, then at step 706, designer 204 generates NLP pipeline 208 based on the user design specified in the user instructions. The UI (e.g., UI 304) can be a component of designer 204 that allows users to manually design NLP pipeline 208, as described above in conjunction with FIGS. 3-5. In some embodiments, the UI includes various panels, such as the panels described above in conjunction with FIGS. 4-5, that allow users to interact with specific UI elements. For example, a pipeline visualization panel could display the overall pipeline logic and visualize the whole flow of NLP pipeline 208.

At step 708, NLP application 106 stores NLP pipeline 208 in a data store (e.g., data store 120). In some embodiments, NLP pipeline 208 can be stored and further configured as services with flexible input parameters to improve the reusability of the pipelines. For example, a pipeline that is stored and configured as a service can be invoked with an API end point. In some embodiments, the stored NLP pipelines and corresponding user input can also be used as examples in few-shot prompts for generating other NLP pipelines for other user inputs.

In sum, techniques are disclosed for generating data processing pipelines, such as NLP pipelines. In some embodiments, an NLP pipeline can be generated either (1) from user input that is processed using a language model, or (2) based on user selections from a list of available services that can be included in the pipeline. When the NLP pipeline is generated from user input that is processed using a language model, the user input can include a natural language description of an NLP task that the pipeline performs. A pipeline application generates a prompt that asks the language model to generate an NLP pipeline and includes the user input, definitions of the available services, and example NLP pipelines that include different combinations of the services and provide few-shot examples for training the language model. The pipeline application inputs the prompt into the language model that processes the prompt to generate a pipeline for the NLP task specified in the user input. Accordingly, predefined services corresponding to the nodes in the pipeline can be included in the pipeline. The disclosed techniques can further include displaying a UI with a graphical representation of the NLP pipeline and information about the nodes of the pipeline. The UI can also present a preview of one or more results generated using the pipeline and/or nodes thereof. Alternatively, to design the pipeline for an NLP task, the user can select from a list of available services, define new nodes of the pipeline that perform one or more of the services, and/or connect multiple nodes. The services can include one or more of a search service, a mapping service, a classification service, a clustering service, an NER service, an inferencing service, an embedding service, a machine learning model training service, and/or an NER enrichment service. The generated pipeline can be stored and used to process data, as well as to provide one of a number of examples in a few-shot prompt asking a language model to generate an NLP pipeline, as described above. In some embodiments, the generated pipeline can be scheduled to run at specific times or be triggered to run by an external signal, such as the receipt of specific data that the pipeline can process.

At least one technical advantage of the disclosed techniques relative to the prior art is that, with the disclosed techniques, data processing pipelines, including pipelines for NLP tasks, can be generated without writing program code. Instead, the disclosed techniques provide predefined services that can be selected via a user interface to efficiently design data processing pipelines. In addition, the disclosed techniques permit data processing pipelines to be generated from textual input using a language model. These technical advantages provide one or more technological improvements over prior art approaches.

1. In some embodiments, a computer-implemented method for generating data processing pipelines comprises receiving user input via a user interface, and generating, based on the user input, a data processing pipeline that includes a set of predefined services, wherein the set of predefined services are associated with the user input.

2. The computer-implemented method of clause 1, wherein the user input includes a natural language text, and generating the data processing pipeline comprises processing the user input via a trained language model.

3. The computer-implemented method of clauses 1 or 2, wherein generating the data processing pipeline comprises generating a prompt that includes the user input, one or more definitions of one or more predefined services, and one or more examples of other user inputs and associated data processing pipelines, and processing the prompt using a trained language model to generate the data processing pipeline.

4. The computer-implemented method of any of clauses 1-3, wherein the user input includes at least one of one or more interactions with the user interface to select the set of predefined services or one or more interactions with the user interface to configure the data processing pipeline.

5. The computer-implemented method of any of clauses 1-4, wherein the set of predefined services includes at least one of a search service, a mapping service, a classification service, a clustering service, a name-entity recognition (NER) service, an inferencing service, an embedding service, a machine learning model training service, a language model service, an agent, a metrics computation service, a growth computation service, a scheduling service, or an NER enrichment service.

6. The computer-implemented method of any of clauses 1-5, further comprising registering each predefined service included in the set of predefined services.

7. The computer-implemented method of any of clauses 1-6, further comprising computing a result using at least one predefined service included in the set of predefined services, and displaying the result via the user interface.

8. The computer-implemented method of any of clauses 1-7, further comprising executing the data processing pipeline in response to receiving a triggering signal.

9. The computer-implemented method of any of clauses 1-8, further comprising executing the data processing pipeline according to a schedule.

10. The computer-implemented method of any of clauses 1-9, wherein the data processing pipeline is configured to process natural language text.

11. In some embodiments, one or more non-transitory computer-readable storage media include instructions that, when executed by one or more processing units, cause the one or more processing units to perform steps for generating data processing pipelines, the steps comprising receiving user input via a user interface, and generating, based on the user input, a data processing pipeline that includes a set of predefined services, wherein the set of predefined services are associated with the user input.

12. The one or more non-transitory computer-readable storage media of clause 11, wherein the user input includes a natural language text, and generating the data processing pipeline comprises processing the user input via a trained language model.

13. The one or more non-transitory computer-readable storage media of clauses 11 or 12, wherein generating the data processing pipeline comprises generating a prompt that includes the user input, one or more definitions of one or more predefined services, and one or more examples of other user inputs and associated data processing pipelines, and processing the prompt using a trained language model to generate the data processing pipeline.

14. The one or more non-transitory computer-readable storage media of any of clauses 11-13, wherein the user input includes at least one of one or more interactions with the user interface to select the set of predefined services or one or more interactions with the user interface to configure the data processing pipeline.

15. The one or more non-transitory computer-readable storage media of any of clauses 11-14, wherein the set of predefined services includes at least one of a search service, a mapping service, a classification service, a clustering service, a name-entity recognition (NER) service, an inferencing service, an embedding service, a machine learning model training service, a language model service, an agent, a metrics computation service, a growth computation service, a scheduling service, or an NER enrichment service.

16. The one or more non-transitory computer-readable storage media of any of clauses 11-15, wherein the instructions, when executed by the one or more processing units, further cause the one or more processing units to perform the step of executing the data processing pipeline either in response to receiving a triggering signal or according to a schedule.

17. The one or more non-transitory computer-readable storage media of any of clauses 11-16, wherein the triggering signal comprises a pre-save and or a post-save signal.

18. The one or more non-transitory computer-readable storage media of any of clauses 11-17, wherein the instructions, when executed by the one or more processing units, further cause the one or more processing units to perform the step of generating, via a trained language model, another data processing pipeline based on another user input and the data processing pipeline.

19. The one or more non-transitory computer-readable storage media of any of clauses 11-18, wherein the instructions, when executed by the one or more processing units, further cause the one or more processing units to perform the step of storing the data processing pipeline in a data store.

20. In some embodiments, a system comprises one or more memories storing instructions, and one or more processors that are coupled to the one or more memories and, when executing the instructions, are configured to receive user input via a user interface, and generate, based on the user input, a data processing pipeline that includes a set of predefined services, wherein the set of predefined services are associated with the user input.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating data processing pipelines, the method comprising:
receiving user input via a user interface; and
generating, based on the user input, a data processing pipeline that includes a set of predefined services, wherein the set of predefined services are associated with the user input.

2. The computer-implemented method of claim 1, wherein the user input includes a natural language text, and generating the data processing pipeline comprises processing the user input via a trained language model.

3. The computer-implemented method of claim 1, wherein generating the data processing pipeline comprises:
generating a prompt that includes the user input, one or more definitions of one or more predefined services, and one or more examples of other user inputs and associated data processing pipelines; and
processing the prompt using a trained language model to generate the data processing pipeline.

4. The computer-implemented method of claim 1, wherein the user input includes at least one of one or more interactions with the user interface to select the set of predefined services or one or more interactions with the user interface to configure the data processing pipeline.

5. The computer-implemented method of claim 1, wherein the set of predefined services includes at least one of a search service, a mapping service, a classification service, a clustering service, a name-entity recognition (NER) service, an inferencing service, an embedding service, a machine learning model training service, a language model service, an agent, a metrics computation service, a growth computation service, a scheduling service, or an NER enrichment service.

6. The computer-implemented method of claim 1, further comprising registering each predefined service included in the set of predefined services.

7. The computer-implemented method of claim 1, further comprising:
computing a result using at least one predefined service included in the set of predefined services; and
displaying the result via the user interface.

8. The computer-implemented method of claim 1, further comprising executing the data processing pipeline in response to receiving a triggering signal.

9. The computer-implemented method of claim 1, further comprising executing the data processing pipeline according to a schedule.

10. The computer-implemented method of claim 1, wherein the data processing pipeline is configured to process natural language text.

11. One or more non-transitory computer-readable storage media including instructions that, when executed by one or more processing units, cause the one or more processing units to perform steps for generating data processing pipelines, the steps comprising:
receiving user input via a user interface; and
generating, based on the user input, a data processing pipeline that includes a set of predefined services, wherein the set of predefined services are associated with the user input.

12. The one or more non-transitory computer-readable storage media of claim 11, wherein the user input includes a natural language text, and generating the data processing pipeline comprises processing the user input via a trained language model.

13. The one or more non-transitory computer-readable storage media of claim 11, wherein generating the data processing pipeline comprises:
generating a prompt that includes the user input, one or more definitions of one or more predefined services, and one or more examples of other user inputs and associated data processing pipelines; and
processing the prompt using a trained language model to generate the data processing pipeline.

14. The one or more non-transitory computer-readable storage media of claim 11, wherein the user input includes at least one of one or more interactions with the user interface to select the set of predefined services or one or more interactions with the user interface to configure the data processing pipeline.

15. The one or more non-transitory computer-readable storage media of claim 11, wherein the set of predefined services includes at least one of a search service, a mapping service, a classification service, a clustering service, a name-entity recognition (NER) service, an inferencing service, an embedding service, a machine learning model training service, a language model service, an agent, a metrics computation service, a growth computation service, a scheduling service, or an NER enrichment service.

16. The one or more non-transitory computer-readable storage media of claim 11, wherein the instructions, when executed by the one or more processing units, further cause the one or more processing units to perform the step of executing the data processing pipeline either in response to receiving a triggering signal or according to a schedule.

17. The one or more non-transitory computer-readable storage media of claim 16, wherein the triggering signal comprises a pre-save and or a post-save signal.

18. The one or more non-transitory computer-readable storage media of claim 11, wherein the instructions, when executed by the one or more processing units, further cause the one or more processing units to perform the step of generating, via a trained language model, another data processing pipeline based on another user input and the data processing pipeline.

19. The one or more non-transitory computer-readable storage media of claim 11, wherein the instructions, when executed by the one or more processing units, further cause the one or more processing units to perform the step of storing the data processing pipeline in a data store.

20. A system, comprising:
one or more memories storing instructions; and
one or more processors that are coupled to the one or more memories and, when executing the instructions, are configured to:
receive user input via a user interface, and
generate, based on the user input, a data processing pipeline that includes a set of predefined services, wherein the set of predefined services are associated with the user input.
